(19) United States
(12) Patent Application Publication
(10) Pub. No.: US 2014/0243036 A1
(43) Pub. Date: Aug. 28, 2014

(54) SYSTEM AND METHOD FOR EMERGENCY RESPONSE

(71) Applicant: Phillip A. Kouwe, Mooresville, NC (US)

(72) Inventor: Phillip A. Kouwe, Mooresville, NC (US)

(21) Appl. No.: 14/192,080

(22) Filed: Feb. 27, 2014

Related U.S. Application Data
(60) Provisional application No. 61/770,209, filed on Feb. 27, 2013.

(51) Int. Cl. H04M 11/04

(52) U.S. Cl. CPC H04M 11/04
USPC 455/521

(57) ABSTRACT

A plurality of portable display devices are wirelessly connected to a central server which is connected to a computer aided dispatch center.

### FIELD OF THE INVENTION

The present invention relates to a system for use by emergency responders. More particularly, the present invention relates to a communication, data and control system which is especially well adapted for use by police, firefighters, and other emergency responders in medium and small community emergency response departments.

### BACKGROUND OF THE INVENTION

Systems using modern communication equipment and computers with software applications useful to enhance public safety are being used more and more often by police and fire departments as well as other emergency response departments. However, there has been little focus on using technologies adapted for the burgeoning tablet computer hardware platform or the interoperability of centralized “cloud” servers. While current systems involve sophisticated technology and are very useful for those who can afford them, there remains a need for systems which are less expensive. Thus, the present invention is intended to provide a system which involves tablet-based operational response software for fire and emergency medical services.

While existing high-end computer-aided dispatch (CAD) software suites provide both real time incident site and nature information, as well as stored property and occupant data, these systems operate on highly specialized enterprise hardware and software architecture. They are currently used by only a small percentage of fire and emergency medical services, typically in well-funded urban areas.

There is a need for systems which are relatively inexpensive and hence, affordable, by smaller departments. Such affordable systems may still focus on early-stage mobile computing technologies. Thus, the present invention employs mobile computing technology, particularly inexpensive tablet computers and cellular broadband devices or the like, in a system for providing emergency incident information, stored pre-incident response data, and command communications to emergency responders in the field. The present invention provides a system which manages the flow of response information from a dispatch center through an information storage server and out to a responder's tablet computer in the field. The present invention permits the communication of incident data between tablet computers in the field. The present system leverages existing open-source and cloud-based software features possible, integrating them with server-tablet connectivity and communication.

The present invention has a unique approach and is capable of providing many of the sophisticated capabilities of information exchange needed for firefighters and other responders to safely mitigate emergencies. The present system can be provided at a reasonable cost, thus making it available to a large portion of the emergency response market that does not currently have access to an enterprise CAD-client software solution or the information it provides when responding out in the field.

The present system will be able to use the expanding capability of today's modern tablet computer platforms and their associated 3G and 4G cellular broadband communications backbone, as well as future public safety broadband networks such as the United States FirstNet, currently in design phase. The present system is capable of automatically delivering critical incident information and pre-incident planning data to an emergency responder at point of dispatch. This is currently impossible in the vast majority of fire departments in America. Current technology to provide in-vehicle electronic data to emergency responders is all but a dream for most responders. However, the present system provides this capability using standard, commercially available, “off-the-shelf” hardware running software that harnesses as much existing open-source or low-cost application technologies as possible, now tailored to the unique needs of emergency responders. The result is a system that can be provided at a fraction of the cost of existing similar services, bringing it within reach of thousands of fire departments nationwide.

Further understanding of the present invention will be had from the following specification and claims, taken in conjunction with the accompanying drawings.

### BRIEF DESCRIPTION OF THE DRAWINGS

FIG. 1 is a block diagram illustrating information capabilities according to the present invention; And

FIG. 2 is a block diagram illustrating communication interconnections of a preferred embodiment of the present invention.

### SUMMARY OF THE INVENTION

An emergency response system has a plurality of tablet computers wirelessly connected to a central server which is connected to one or more computer aided dispatch centers and to other information providers useful for emergency response.

### DESCRIPTION OF THE INVENTION

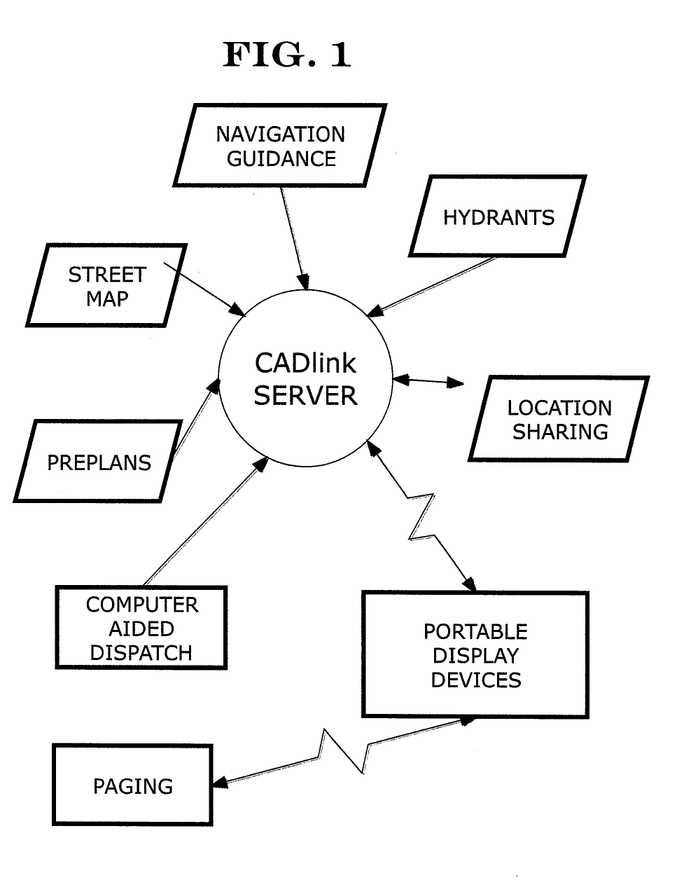

Now referring to the FIG. 1, a preferred embodiment of a streetwise tactical communication system of the present invention has a server, indicated as a CADlink server which is connected wirelessly to a plurality of portable display devices such as conventional tablet computers. The CADlink server is also in communication with a plurality of information sources providing information useful to an emergency responder. As illustrated by example in FIG. 1, such sources of information include navigation guidance, street maps, emergency preplans, location of fire hydrants and the like. The Cadlink server is also connected to a location sharing computer which can locate the portable display devices, for example using GPS technology, and provide such information to other display devices so that the individual users of such devices are aware of the location of other emergency responders. The system functions using a unique approach to data management and transfer which captures the legacy systems now in place in the United States and many other countries. The CADlink server is in communication with one or more computer aided dispatchers (CAD) so that the CAD of a particular agency can communicate with and dispatch each responder through the responder's portable display device. Each responder can also be paged over each respective display device directly from a paging center as shown in the figure or through the CADlink server.

The present system can optionally have many different features such as pushing incident location and type to assigned display devices such as tablets with an audible alert as well as mapping of incidents automatically, with familiar “pinch-zoom” interface. Also, the location of other responding tablets/units can be shown in real time or near real time while responders are navigating to the response site or are already at the site. Enroute to the response site, community hazards can be displayed graphically on a tactical map for review by the responder. Navigational routing is available, with turn-by-turn directions and a hydrant layer can be overlayed on the display to show the location data for water supply and touch to display data can provide detailed information about the supply. The responder can switch to satellite photo view for enhanced situational awareness and an interactive 360 degree photo view may be provided to the responder to provide situational awareness even before the responder arrives at the site. Tactical waypoints can be dropped on the map and instantly synchronized to all responding tablets for designation of staging areas, incident hazards, fire progression and the like. Pre-incident plans can be stored in the server and accessed on any responding tablet. A complete front-end pre-incident planning survey could be stored on the server and provided to the responder enroute or at the site. New pre-plans can be synchronized to the server for immediate use. Pre-incident planning photos can be pushed to tablets. An instant photo “share” feature can push incident photos to other responding tablets. Unit status timestamps can be sent to the server for later retrieval to enhance documentation. Agency log, accessible from any computer, can record every event and activity

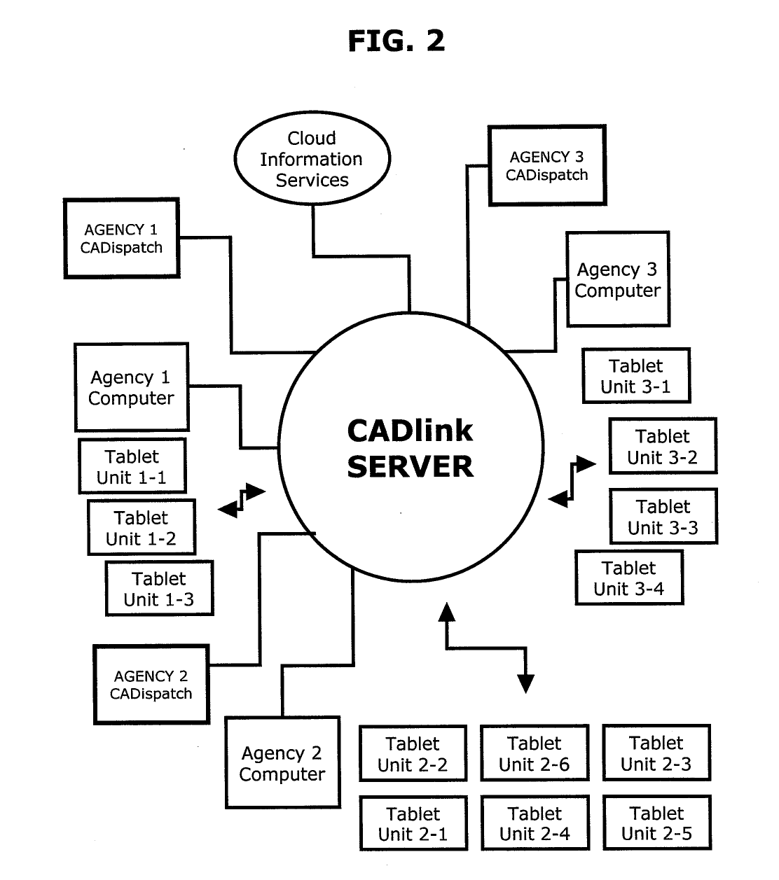

As illustrated in FIG. 2, it is contemplated that the present emergency response system will provide a tactical communication system broadly comprising a plurality of portable display devices such as tablet computers which are linked to a central computer server, indicated in the figures as CADlink server, over standard cellular broadband or wireless services. The central server is also in communication with one or more, for example three as shown in FIG. 2, computer aided dispatch (CAD) centers to receive basic incident dispatch data from a particular agency's computer aided dispatch (CAD) center. This communication can be by either email or SMS text messaging, or any other suitable means. Once the central server has received the call, the critical data elements of calltype and location will be parsed from the message and transmitted to the appropriate portable display devices. Based on the address of the call, the central server will also provide any stored pre-incident plan data, mapping data, hydrant information, photos or nearly any other type of information that can be stored and accessed from a database keyed by the address field.

For example, imagine that a firefighter is in the fire station cooking dinner for the crew. A call crackles over the radio speaker on the wall indicating that a structure fire has been reported at 5327 Arlington Avenue. The crew of Engine 1 moves quickly toward the fire apparatus. On the way, the engine's Captain picks up a small tablet computer that is sitting in a drop-in charger near the door. As he walks toward the engine, the tablet computer begins vibrating and its screen announces “alert received”. Climbing into the cab of the engine, the Captain opens the tablet where he now sees an area map on the screen with a flashing icon pointing to the exact address of 5327 Arlington Avenue. Pressing his finger to the screen on the flashing icon, a box pops up with additional information about the call as it was reported to the dispatcher. Near the bottom of the screen, he presses on a “Navigate To” button and in moments the screen is providing turn by turn directions to the incident. The fire engine roars out the door. As they turn down the busy street, following the directions being provided by the tablet, the Captain clicks another button to change to a satellite view of the incident and surrounding neighborhood. Pinching the screen to zoom in, he sees what appears to be a dirt road coming off another street that passes right behind the fire building. Picking up his radio, he instructs another responding unit to respond to that street and approach the rear of the building by way of the dirt drive. Clicking back to his own map screen, he selects a button labeled “Hydrants” and, instantly, the layout on the map includes flashing icons indicating the location of the nearest fire hydrant. Using the on-screen measuring tool, he is able to determine that the closest hydrant is 800 feet from the fire building. Based on that information, he requests an additional engine be dispatched for relay pumping. Clicking on the hydrant icon, he is able to provide the other engine the exact hydrant number to report to. The other engine crew enters this hydrant number into their tablet and immediately follow on-screen navigation toward that hydrant. Now that he is satisfied that he has sufficient resources assigned to the incident, the Captain clicks on another tablet button labeled “Pre-Incident Data”, which is flashing to indicate that a pre-incident plan has been completed for this structure. Clicking on that button, the tablet switches to provide a “Quick Access Data” screen that provides a host of basic, but critical, information about the structure, including what it is used for, what hours it is open, how many occupants it typically has during various hours of the day, the name of the keyholders and their contact phone numbers, what types of utilities serve the structure and so on. Another button accesses additional data about chemicals stored in the building. Another click and he is looking at a diagram of the building and its basic interior layout. He pinch-zooms to see a closer depiction of the electric utility shutoff. There is an optional click that brings up an actual photograph of the shutoff and he tells the firefighters in the rear seat of the engine that the utility is partially hidden behind a large bush to the left of the rear door. After reviewing various other selections of pre-incident plan data, he returns to the main map screen and selects “View Units” to display the current location of his unit as well as the other fire units that are responding to the scene. He quickly sees that his unit should arrive first, followed by Engine 2 about 30 seconds later. Based on that, he tells Engine 2 to use caution at the intersection of 53rd and Arlington, since they will both approach the intersection close to the same time. Engine 2's Captain responds back that he is also watching that on his tablet map. As Engine 1 pulls up in front of the structure, heavy smoke can be seen emitting from a window on the west side of the structure. The Captain quickly clicks a button on the tablet that automatically records his arrival time and a prompt asks if he wishes to record an “Arrival Photo”. He clicks “yes” and holds the tablet's camera up to take a quick time-stamped photo of the conditions on arrival. He knows that photo will assist the fire investigators later. Another button press transmits the photo and makes it available to other tablets. Satisfied that they have all the critical information they need, the crew jumps off the fire engine and goes to work.

While preferred embodiments of the present invention have been disclosed in the foregoing disclosure, the present invention is subject to variation and modification within the broad scope of the invention For example, various information features could be included or not included depending upon the particular choices of the user. Therefore, it will be appreciated by those skilled in the art that the present invention is intended to be limited only by the scope of the following claims.

What is claimed is:

1. A streetwise tactical communication system comprising:
A plurality of portable display devices;
A central server;
A computer aided dispatch center;
said portable display devices being in communication with said central server and said central server being in communication with said computer aided dispatch center.
